(19) United States
(12) Patent Application Publication
(10) Pub. No.: US 2003/0140719 A1
(43) Pub. Date: Jul. 31, 2003

(54) Anti-backlash gear

(76) Inventors: Joel Scott Johnson, Petersborough (GB); Kevin J. Knox, Peoria, IL (US)

Correspondence Address: CATERPILLAR INC., 100 N.E. ADAMS STREET, PATENT DEPT., PEORIA, IL, 616296490

(21) Appl. No.: 10/060,742

(22) Filed: Jan. 30, 2002

(51) Int. Cl. F16H 1/12; F16H 55/18

(52) U.S. Cl. 74/421 R; 74/409

(57) ABSTRACT

An anti-backlash gear system including a splined shaft and a gear is disclosed. The splined shaft has at least one spline. The gear has a splined bore having at least one spline, through which the splined shaft passes. The gear and the shaft have a clearance therebetween. The splined bore and the splined shaft are engaged in a driving direction, and the splined bore and the splined shaft are disengaged, thereby producing a backlash motion, in a direction opposite the driving direction.

### TECHNICAL FIELD

This invention is of the form of a system to drive a gear, and, more particularly, to such a system providing an anti-backlash feature.

### BACKGROUND

Many different machines include a shaft, or hub, turning in a driving direction. The shaft takes power from a source and transmits it to a driving gear, which then transmits the motion on to a driven gear. The shaft often includes splines which interact with splines on an inner bore of the driving gear to turn the driving gear in the driving direction. As the shaft turns in the driving direction, irregularities or periodic catches in the source can cause the shaft to momentarily slow, stop, or even turn in a direction opposite the driving direction. All of these unwanted motions are termed “backlash” and can cause damage to the components of the machine, as well as accelerating wear and decreasing power transmission in the machine.

U.S. Pat. No. 6,098,726, issued Aug. 8, 2000 to Taylor et al. (hereafter referenced as '726) discloses a torque transmitting device including a coupling which permits limited relative rotation between two members about a common central axis, but provides a resistance to rotation of the first member relative to the second member in a forward drilling direction which is greater than its resistance to relative rotation in the reverse direction.

Accordingly, the art has sought a method and apparatus of an anti-backlash gear system which: prevents damage from backlash; contains a limited number of individual parts; absorbs backlash motion without permitting the motion to be transmitted; may be used in a timely and efficient manner; and is more economical to manufacture and use.

The present invention is directed to overcoming one or more of the problems as set forth above.

### SUMMARY OF THE INVENTION

In an embodiment of the present invention, an anti-backlash gear system including a splined shaft and a gear is disclosed. The splined shaft has at least one spline. The gear has a splined bore having at least one spline, through which the splined shaft passes. The gear and the shaft have a clearance therebetween. The splined bore and the splined shaft are engaged in a driving direction, and the splined bore and the splined shaft are disengaged, thereby producing a backlash motion, in a direction opposite the driving direction.

In an embodiment of the present invention, a torsionally elastic coupling having a driving shaft, a driven ring, and a radial member is disclosed. The driving shaft has at least one shaft backlash relief pocket. The driven ring surrounds the driving shaft and has at least one ring backlash relief pocket. The radial member is attached to the driving shaft along a longitudinal direction adjacent to the shaft backlash relief pocket and contacts the driven ring adjacent the ring backlash relief pocket. The radial member is engageable to transmit a driving force from the driving shaft to the driven ring in a driven direction and disengageable to cushion a backlash force between the driving shaft and the driven ring in a direction opposite the driving direction.

In an embodiment of the present invention, a method of cushioning a backlash force from a driven ring to a driving shaft is disclosed. The driving shaft has at least one shaft backlash pocket and is surrounded by the driven ring, which has at least one ring backlash pocket. The method includes the steps of moving the driving shaft in a driving direction to produce a driving force, and transmitting the driving force to the driven ring via a radial member contacting both the shaft backlash pocket and the ring backlash pocket in an initial position. The method also includes the steps of providing a backlash force in a direction opposite the driving direction, and responsively allowing the radial member to move from the initial position within at least one of the shaft backlash pocket and the ring backlash pocket. The method additionally includes the steps of removing the backlash force, providing the driving force, and responsively allowing the radial member to return to the initial position.

### BRIEF DESCRIPTION OF THE DRAWINGS

FIG. 1 is a cutaway drawing of an anti-backlash gear system of a preferred embodiment of the present invention.

### DETAILED DESCRIPTION

A preferred embodiment of the present invention provides an apparatus and method of an anti-backlash gear system.

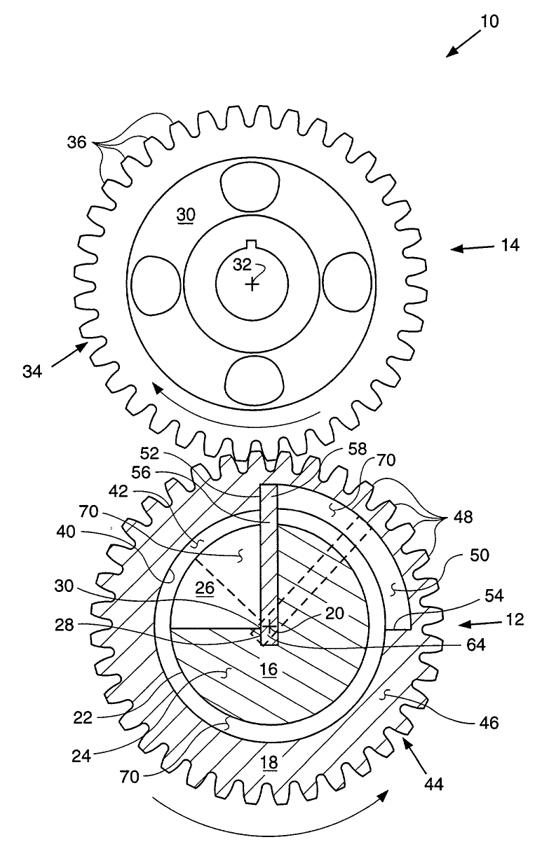

FIG. 1 depicts an anti-backlash gear system 100 according to the present invention. A splined shaft 102 has at least one spline 104 thereon. By “spline”, what is meant is a substantially radially oriented protrusion or plane, such as a shouder, vane, leaf spring, rib, tooth, or the like. The anti-backlash gear system 100 will be described herein as having one spline 104 and associated elements for the sake of simplicity, but any number of splines 104 could be present without departing from the spirit and scope of the present invention.

As shown in FIG. 1, the spline 104 of the present invention is anchored to the splined shaft 102 by a first end 106. The spline 104 need only be contacting the splined shaft 102 or any other element, not be attached thereto, but will be referred to as such for ease of reference in the below description.

A gear 108 has a splined bore 110 therein, having at least one spline 104, shown in FIG. 1 as a shoulder. The splined shaft 102 passes through the splined bore 110, leaving a clearance 112 therebetween.

At least one of the splined shaft 102 and the splined bore 110 has a spline pocket 116 adjacent to the spline 104. Preferably, the spline pocket 116 has a viscoelastic material therein. Optionally, the spline pocket 116 may have a shaped profile (not shown) to help control the motion of the spline 104 in the spline pocket 116. Also, the spline 104 may be flexible such that a second end 118 can be moved while the first end 106 remains anchored or vice versa.

While aspects of the present invention have been particularly shown and described with reference to the preferred embodiment above, it will be understood by those skilled in the art that various additional embodiments may be contemplated without departing from the spirit and scope of the present invention. For example, the viscoelastic material could be a foam or fluid, the spline could be anchored to the gear 108, or the spline pocket 116 could be of any suitable configuration. However, a device or method incorporating such an embodiment should be understood to fall within the scope of the present invention as determined based upon the claims below and any equivalents thereof.

Industrial Applicability

As the splined shaft 102 rotates in the driving direction 114, the spline 104 of the splined shaft 102 transmits motion from the splined shaft 102 through contact with the spline 104 of the splined bore 110, thus driving the gear 108 in the driving direction. When a backlash situation occurs—that is, when either the splined shaft 102 or the gear 108 momentarily ceases to rotate in the driving direction 114, the spline 104 of the splined shaft 102 loses contact with the spline 104 of the splined bore 110. The spline 104 of the splined shaft 102 then moves into at least a portion of the spline pocket 116 of the splined bore 110 until the backlash motion is removed, at which time the spline 104 of the splined shaft 102 reengages the spline 104 of the splined bore 110 to continue operating normally.

In a backlash situation, should the spline 104 of the splined shaft 102 completely traverse the spline pocket 116 of the splined bore 110, an outboard end 120 of the spline pocket 116 will contact the spline 104 of the splined shaft 102 and bend the second end 118 with respect to the first end 106, forcing the spline 104 of the splined shaft 102 to travel into the spline pocket 116 of the splined shaft 102. If the backlash force is significant enough to force the spline 104 of the splined shaft 102 to contact the outboard end 120 of the spline pocket 116 of the splined shaft 102, the motion of the splined shaft 102 and gear 108 may hesitate or “catch”, but it is anticipated that any momentary backlash motion will cease before such a hesitation occurs.

Should the backlash be great enough to cause the spline 104 of the splined shaft 102 to flex and travel into the spline pocket 116 of the splined shaft 102, the spline pocket 116 of the splined shaft 102 may be contoured or shaped to allow for a smooth or controlled return of the spline 104 of the splined shaft 102 to its normal driving position.

The spline 104 could be attached to either the splined shaft 102 or the splined bore 110, or could be free-floating. It should be obvious to one skilled in the art that operation of the present invention will not be materially affected by the attachment condition of the spline 104.

Preferably, the spline pockets 116 contain therein a viscoelastic material which acts to absorb and dissipate some of the backlash force. The amount and type of such material can be adjusted to “tune” the anti-backlash gear system 100 for a desired result.

The apparatus and method of certain embodiments of the present invention, when compared with other methods and apparatus, may have the advantages of: preventing damage from backlash; containing a limited number of individual parts; absorbing backlash motion without permitting the motion to be transmitted; may be used in a timely and efficient manner; and being more economical to manufacture and use. Such advantages are particularly worthy of incorporating into the design, manufacture, and operation of gears. In addition, the present invention may provide other advantages that have not yet been discovered.

Other aspects, objects, and advantages of the present invention can be obtained from a study of the drawings, the disclosure, and the appended claims.

What is claimed is:

1. An anti-backlash gear system, comprising:
a splined shaft having at least one spline thereon; and
a gear having a splined bore therein, having at least one spline, through which the splined shaft passes, the gear and the shaft having a clearance therebetween, the splined bore and the splined shaft being engaged in a driving direction, and the splined bore and the splined shaft being disengaged, thereby producing a backlash motion, in a direction opposite the driving direction.

2. The anti-backlash gear system of claim 1, wherein at least one of the splined bore and splined shaft include at least one spline pocket adjacent to the spline

3. The anti-backlash gear system of claim 2, wherein the spline pocket has a viscoelastic material therein for reducing or cushioning the amount of backlash motion.

4. A torsionally elastic coupling, comprising:
a driving shaft having at least one shaft backlash relief pocket;
a driven ring surrounding the driving shaft and having at least one ring backlash relief pocket; and
a radial member being attached to the driving shaft along a longitudinal direction adjacent to the shaft backlash relief pocket and contacting the driven ring adjacent the ring backlash relief pocket, the radial member engageable to transmit a driving force from the driving shaft to the driven ring in a driven direction and disengageable to cushion a backlash force between the driving shaft and the driven ring in a direction opposite the driving direction.

5. The torsionally elastic coupling of claim 4, wherein the radial member is flexible and permitted to bend from a driving position to a flexed position as the torsionally elastic coupling is operating in a direction opposite the driving direction.

6. The torsionally elastic coupling of claim 5, wherein the shaft backlash relief pocket is contoured to allow for a controllable return of the radial member from a flexed position to a driving position.

7. The torsionally elastic coupling of claim 4, wherein at least one of the shaft backlash relief pocket and the ring backlash relief pocket contains a viscoelastic material acting to absorb and dissipate at least a portion of the backlash force.

8. A method of cushioning a backlash force from a driven ring to a driving shaft, having at least one shaft backlash pocket, surrounded by the driven ring, having at least one ring backlash pocket, comprising the steps of:
moving the driving shaft in a driving direction to produce a driving force;
transmitting the driving force to the driven ring via a radial member contacting both the shaft backlash pocket and the ring backlash pocket in an initial position;
providing a backlash force in a direction opposite the driving direction;
responsively allowing the radial member to move from the initial position within at least one of the shaft backlash pocket and the ring backlash pocket;
removing the backlash force;
providing the driving force; and
responsively allowing the radial member to return to the initial position.

9. The method of claim 8, further including the step of:
resisting movement of the radial member with a material located in at least one of the shaft backlash pocket and the ring backlash pocket.

10. The method of claim 8, further including the step of:
controlling movement of the radial member with a profile of at least one of the shaft backlash pocket and the ring backlash pocket.
